(19) United States
(12) Patent Application Publication
(10) Pub. No.: US 2015/0361272 A1
(43) Pub. Date: Dec. 17, 2015

(54) RUST PREVENTIVE OIL COMPOSITION

(71) Applicant: JX NIPPON OIL & ENERGY CORPORATION, Tokyo (JP)

(72) Inventors: Koichi YOSHIDA, Tokyo (JP); Tadaaki MOTOYAMA, Tokyo (JP); Junichi SHIBATA, Tokyo (JP)

(73) Assignee: JX NIPPON OIL & ENERGY CORPORATION, Tokyo (JP)

(21) Appl. No.: 14/762,910

(22) PCT Filed: Jan. 30, 2014
(86) PCT No.: PCT/JP2014/052149

§ 371 Date: Jul. 23, 2015

(30) Foreign Application Priority Data
Jan. 30, 2013 (JP) 2013-015633

(51) Int. Cl. C09D 5/08; C09D 7/12

(52) U.S. Cl. CPC C09D 5/08; C09D 7/1233

(57) ABSTRACT

The rust preventive oil composition of the present invention comprises a base oil comprising a mineral oil and a naphthenic acid salt, with the base oil content of 50 mass % or more based on the total amount of the rust preventive oil composition. According to the present invention, a rust preventive oil composition capable of suppressing the generation of rust for a long period can be provided, having both of a water removal property and a finger print removal property.

### TECHNICAL FIELD

The present invention relates to a rust preventive oil composition.

### BACKGROUND ART

In many cases, metal members comprising iron as a main component are manufactured through working such as cutting and pressing. During manufacturing or when shipping as products, a rust preventive oil is applied for the purpose of preventing discoloration called rust or stain. The main purpose of the use of the rust preventive oil is to form a film on the metal surface to block oxygen, and thereby preventing oxidation of metal, that is, rust.

However, if a chloride or water is attached to the metal surface, it becomes difficult for the rust preventive oil to sufficiently exert its effect. For example, in the case where a metal working oil containing a chlorine extreme-pressure agent is used for a preceding process of working, in order to obtain a sufficient rust preventive property, the chloride that is a rust generation factor needs to be removed in advance. Thus, in many cases, after washing and removing the chloride with a finger print remover type rust preventive oil called NP-0 specified by JIS K 2246, a rust preventive oil is used.

Furthermore, when a water-soluble working oil is used, moisture is considered to be attached. Also in this case, moisture needs to be removed before using a rust preventive oil as is the case in chlorine. An oil solution whose water displacement property is enhanced is sometimes used to remove water. The water displacement property herein means performance by which an additive agent in the oil solution penetrates between water and metal, and water is removed from the metal surface. Oil solutions corresponding to NP-3-1 and NP-3-2 classified by JIS K 2246 also have a water displacement property, but this relates to a rust preventive property when moisture is mixed in a rust preventive oil and does not specify performance capable of removing water from a metal surface (see Non Patent Literature 1). Hereinafter, in order to avoid confusion, performance to remove water from a metal surface is called a “water removal property”, and is distinguished from the water displacement property specified by JIS.

As described above, in order to carry out rust preventive treatment for metal to which moisture is attached, firstly, moisture is removed by washing with an oil solution which excels in water removal property, and then, a rust preventive oil needs to be applied. However, in many cases, the two processes, “removal of moisture” and “application of rust preventive oil”, cannot be carried out due to causes such as productivity and cost, and an oil solution capable of unifying treatment is required. However, it is very much a situation that treatment of an oil solution having a water removal property lacks a rust preventive property and a sufficient rust preventive property cannot be obtained by applying a rust preventive oil without a water removal process (for example, see Patent Literatures 1 and 2).

### CITATION LIST

### Patent Literature

Patent Literature 1: Japanese Patent Application Laid-Open No. 2001-89795
Patent Literature 2: Japanese Patent Application Laid-Open No. 2001-89798

### Non Patent Literature

Non Patent Literature 1: Junichi Shibata, ENEOS Technical Review, vol. 50, No. 3, page 45

### SUMMARY OF INVENTION

### Technical Problem

One of the reasons for an oil solution having a water removal property not achieving a sufficient rust preventive property is insufficient stability of the oil solution for water. One of the additive agents used for obtaining an excellent rust preventive property is an ester, which is hydrolyzed due to continuous contact with water so as to lose the original performance.

Further, a finger print remover-type rust preventive oil includes water blended in oil for dissolving a finger print (i.e. chloride), and consequently, use of an ester to be easily hydrolyzed is not preferred as in the case of an oil solution having a water removal property, so that imparting a sufficient rust preventive property to the finger print remover-type rust preventive oil is generally difficult.

Furthermore, due to frequent use of hydroscopic material such as sulfonates in conventional washing rust preventive oils and rust preventive oils, the ester is hydrolyzed by the naturally absorbed moisture, causing the problem of gradually reducing the performance of the oil solution. In other words, the main problem of rust preventive oils is to maintain the stability of rust preventive oils to water, which is one of the most common causes of rust generation.

The present invention has been made in view of these circumstances, and it is an object of the present invention to provide a rust preventive oil composition excellent in rust preventive property applicable to metal parts such as steel sheets, bearings, steel balls, and guide rails, having both of a water removal property and finger print removal property.

### Solution to Problem

The present inventors made extensive research for the solution of the above-described problem, and found that the stable rust preventive property can be achieved even after a long contact with moisture by combining a specific base oil and a naphthenic acid salt and satisfying specific conditions on the content of the base oil so as to complete the present invention.

Namely, the rust preventive oil composition of the present invention comprises: (A) a base oil comprising a mineral oil; and (B) a naphthenic acid salt; the content of the base oil being 50 mass % or more based on a total amount of the rust preventive oil composition.

The mineral oil is preferably a mixture of: (a1) a mineral oil having a kinematic viscosity at 40° C. of 7 mm²/s or less; and (a2) a mineral oil having a kinematic viscosity at 40° C. of 250 mm²/s or more.

The rust preventive oil composition of the present invention preferably further comprises: (C) a fatty acid amine salt.

The rust preventive oil composition of the present invention preferably further comprises: (D) a sulfuric acid salt.

The rust preventive oil composition of the present invention preferably comprises no ester.

The kinematic viscosity at 40° C. of the rust preventive oil composition of the present invention is preferably 0.5 to 10 mm²/s.

### Advantageous Effects of Invention

According to the present invention, a rust preventive oil composition capable of suppressing the generation of rust for a long period may be provided, having both of a water removal property and a finger print removal property. For example, the rust preventive oil of the present invention has an excellent effect that the time during which Grade A of rust generation (rust generation of 0%) is maintained in a neutral salt water spray test specified by JIS K 2246 “Rust preventive oils” is 16 hours or more.

### DESCRIPTION OF EMBODIMENTS

Hereinafter, a preferred embodiment of the present invention will be described in detail.

A rust preventive oil composition according to the embodiment of the present invention contains: (A) a base oil comprising a mineral oil; and (B) a naphthenic acid salt.

The kinematic viscosity at 40° C. of the mineral oil is preferably 0.5 mm²/s or more, more preferably 1.0 mm²/s or more, and most preferably 1.5 mm²/s or more, though not particularly limited. Further, the kinematic viscosity at 40° C. of the mineral oil is preferably 700 mm²/s or less, more preferably 650 mm²/s or less, and most preferably 600 mm²/s or less. With an excessively low kinematic viscosity, it becomes difficult to form a sufficient oil film to decrease the rust preventive property; while with an excessively high kinematic viscosity, the property for removing the rust generation factor from a metal surface decreases to decrease the rust preventive property.

From the viewpoint of enhancing the rust preventive property, mixing two or more base oils having a different kinematic viscosity is preferred. In this case, it is preferred to mix a mineral oil having a kinematic viscosity at 40° C. of 7 mm²/s or less (hereinafter referred to as “low-viscosity base oil”) and a mineral oil having a kinematic viscosity at 40° C. of 250 mm²/s or more (hereinafter referred to as “high-viscosity base oil”).

The kinematic viscosity at 40° C. of the base oil after mixing is preferably less than 10 mm²/s, though not particularly limited. With an excessively high kinematic viscosity, the effect of enhancing the rust preventive property is hardly obtainable.

Mineral oils as (A) component include those having the above-described kinematic viscosity at 40° C. among paraffinic or naphthenic mineral oils, which are obtainable by arbitrarily combining and applying one or two or more refining means such as solvent deasphalting, solvent extraction, hydrocracking, solvent dewaxing, catalytic dewaxing, hydrorefining, sulfuric acid washing, and clay treatment, with respect to lubricant oil distillate obtained by atmospheric distillation and/or vacuum distillation of crude oil.

Although the aromatic content in the base oil is not particularly limited, the aromatic content in the low-viscosity base oil is preferably 3 mass % or less. When the aromatic content in the low-viscosity base oil is 3 mass % or less, the work environment may be improved, for example, a reduction in odor and skin irritation, and furthermore, water separating performance when a large amount of water is mixed in the rust preventive oil composition may be improved, resulting in an effect of extending life of an oil solution even in the case of removing a large amount of water. The aromatic component means a value measured in conformity with Fluorescent indicator adsorption method of JIS K 2536-1996 “Liquid petroleum products-Testing method of components”.

The content of base oil is 50 mass % or more, preferably 60 mass % or more, more preferably 65 mass % or more, most preferably 70 mass % or more, based on the total amount of the rust preventive oil composition. With an excessively low content of the base oil, the water displacement property tends to decrease, which is not preferred. The upper limit of the content of the base oil is preferably 99.9 mass % or less, more preferably 99 mass % or less, most preferably 98 mass % or less, based on the total amount of the rust preventive oil composition, though not particularly limited. With an excessively high content of the base oil, the rust preventive property decreases, which is not preferred.

In the present embodiment, the base oil may include one or more selected from a carbon hydrate oil such as poly-α-olefin, alkyl benzene, alkyl naphthalene; an ether base oil such as poly-alkylene glycol; and an animal or vegetable oil; other than the mineral oil, as long as the performance of the rust preventive oil composition is not impaired. In the case of a mixed base oil of a mineral oil and another base oil, the content of mineral oil is preferably 40 mass % or more, more preferably 50 mass % or more, furthermore preferably 60 mass % or more, based on the total amount of the base oil.

The naphthenic acid to constitute a naphthenic acid salt as the component (B) may be synthesized or produced from petroleum, including carboxylic acid compounds of cyclopentane, cyclohexane, and a mixture thereof as main components.

In the case that the naphthenic acid salt is an amine salt, examples of the amine include monoamine, polyamine, and alkanolamine.

In the case that the naphthenic acid salt is a metal salt, examples of the metal include zinc, iron, nickel, copper, calcium, manganese, cobalt, and lead; and the naphthenic acid metal salt is preferably a zinc salt, a calcium salt, a copper salt, and a manganese salt, most preferably zinc naphthenate.

The content of naphthenic acid salt is preferably 0.5 mass % or more, more preferably 1 mass % or more, furthermore preferably 2 mass % or more, and preferably 20 mass % or less, more preferably 15 mass % or less, furthermore preferably 10 mass % or less, based on the total amount of the rust preventive oil composition, though not particularly limited. With a content of the naphthenic acid salt less than the lower limit, the water removal property tends to decrease, and with a content of the naphthenic acid salt more than the upper limit, the rust preventive property tends to decrease.

The rust preventive oil composition according to the present embodiment preferably further includes a fatty acid amine salt (C). The fatty acid to constitute the fatty acid amine salt may be a saturated fatty acid or an unsaturated fatty acid, and may be a straight-chain fatty acid or a branched fatty acid. The number of carbon atoms of the fatty acid is preferably 4 to 18, more preferably 6 to 12, though not particularly limited.

Examples of the amines include monoamines, polyamines, and alkanolamines.

Examples of the monoamines include alkylamines such as monomethylamine, dimethylamine, trimethylamine, monoethylamine, diethylamine, triethylamine, monopropylamine, dipropylamine, tripropylamine, monobutylamine, dibutylamine, tributylamine, monopentylamine, dipentylamine, tripentylamine, monohexylamine, dihexylamine, monoheptylamine, diheptylamine, monooctylamine, dioctylamine, monononylamine, monodecylamine, monoundecylamine, monododecylamine, monotridecylamine, monotetradecylamine, monopentadecylamine, monohexadecylamine, monoheptadecylamine, monooctadecylamine, monononadecylamine, monoicosylamine, monohenicosylamine, monodocosylamine, monotricosylamine, dimethyl(ethyl)amine, dimethyl(propyl)amine, dimethyl(butyl)amine, dimethyl(pentyl)amine, dimethyl(hexyl)amine, dimethyl(heptyl)amine, dimethyl(octyl)amine, dimethyl(nonyl)amine, dimethyl(decyl)amine, dimethyl(undecyl)amine, dimethyl(dodecyl)amine, dimethyl(tridecyl)amine, dimethyl(tetradecyl)amine, dimethyl(pentadecyl)amine, dimethyl(hexadecyl)amine, dimethyl(heptadecyl)amine, dimethyl(octadecyl)amine, dimethyl(nonadecyl)amine, dimethyl(icosyl)amine, dimethyl(henicosyl)amine, and dimethyl(tricosyl)amine;

alkenylamines such as monovinylamine, divinylamine, trivinylamine, monopropenylamine, dipropenylamine, tripropenylamine, monobutenylamine, dibutenylamine, tributenylamine, monopentenylamine, dipentenylamine, tripentenylamine, monohexenylamine, dihexenylamine, monoheptenylamine, diheptenylamine, monooctenylamine, dioctenylamine, monononenylamine, monodecenylamine, monoundecenylamine, monododecenylamine, monotridecenylamine, monotetradecenylamine, monopentadecenylamine, monohexadecenylamine, monoheptadecenylamine, monooctadecenylamine, monononadecenylamine, monoicosenylamine, monohenicosenylamine, monodocosenylamine, and monotricosenylamine;
monoamines having an alkyl group and an alkenyl group, such as dimethyl(vinyl)amine, dimethyl(propenyl)amine, dimethyl(butenyl)amine, dimethyl(pentenyl)amine, dimethyl(hexenyl)amine, dimethyl(heptenyl)amine, dimethyl(octenyl)amine, dimethyl(nonenyl)amine, dimethyl(decenyl)amine, dimethyl(undecenyl)amine, dimethyl(dodecenyl)amine, dimethyl(tridecenyl)amine, dimethyl(tetradecenyl)amine, dimethyl(pentadecenyl)amine, dimethyl(hexadecenyl)amine, dimethyl(heptadecenyl)amine, dimethyl(octadecenyl)amine, dimethyl(nonadecenyl)amine, dimethyl(icosenyl)amine, dimethyl(henicosenyl)amine, and dimethyl(tricosenyl)amine;
aromatic-substituted alkylamines such as monobenzylamine, (1-phenethyl)amine, (2-phenethyl)amine (another name: monophenethylamine), dibenzylamine, bis(1-phenethyl)amine, and bis(2-phenethyl)amine (another name: diphenethylamine); cycloalkylamines having the number of carbon atoms of 5 to 16, such as monocyclopentylamine, dicyclopentylamine, tricyclopentylamine, monocyclohexylamine, dicyclohexylamine, monocycloheptylamine, and dicycloheptylamine; monoamines having an alkyl group and a cycloalkyl group, such as dimethyl(cyclopentyl)amine, dimethyl(cyclohexyl)amine, and dimethyl(cycloheptyl)amine; and alkylcycloalkylamines such as (methyl cyclopentyl)amine, bis(methyl cyclopentyl)amine, (dimethyl cyclopentyl)amine, bis(dimethyl cyclopentyl)amine, (ethyl cyclopentyl)amine, bis(ethyl cyclopentyl)amine, (methyl ethyl cyclopentyl)amine, bis(methyl ethyl cyclopentyl)amine, (diethyl cyclopentyl)amine, (methyl cyclohexyl)amine, bis(methyl cyclohexyl)amine, (dimethyl cyclohexyl)amine, bis(dimethyl cyclohexyl)amine, (ethyl cyclohexyl)amine, bis(ethyl cyclohexyl)amine, (methyl ethyl cyclohexyl)amine, (diethyl cyclohexyl)amine, (methyl cycloheptyl)amine, bis(methyl cycloheptyl)amine, (dimethyl cycloheptyl)amine, (ethyl cycloheptyl)amine, (methyl ethyl cycloheptyl)amine, and (diethyl cycloheptyl)amine, and also include all substituted isomers of these monoamines. The monoamines described herein include monoamines such as beef tallow amine, which are derived from oils and fats.

Examples of the polyamines include alkylenepolyamines such as ethylene diamine, diethylene triamine, triethylene tetramine, tetraethylene pentamine, pentaethylene hexamine, propylene diamine, dipropylene triamine, tripropylene tetramine, tetrapropylene pentamine, pentapropylene hexamine, butylene diamine, dibutylene triamine, tributylene tetramine, tetrabutylene pentamine, and pentabutylene hexamine;

N-alkylethyylenediamines such as N-methyl ethylene diamine, N-ethyl ethylene diamine, N-propyl ethylene diamine, N-butyl ethylene diamine, N-pentyl ethylene diamine, N-hexyl ethylene diamine, N-heptyl ethylene diamine, N-octyl ethylene diamine, N-nonyl ethylene diamine, N-decyl ethylene diamine, N-undecyl, N-dodecyl ethylene diamine, N-tridecyl ethylene diamine, N-tetradecyl ethylene diamine, N-pentadecyl ethylene diamine, N-hexadecyl ethylene diamine, N-heptadecyl ethylene diamine, N-octadecyl ethylene diamine, N-nonadecyl ethylene diamine, N-icosyl ethylene diamine, N-henicosyl ethylene diamine, N-docosyl ethylene diamine, and N-tricosyl ethylene diamine;
N-alkenylethylenediamines such as N-vinyl ethylene diamine, N-propenyl ethylene diamine, N-butenyl ethylene diamine, N-pentenyl ethylene diamine, N-hexenyl ethylene diamine, N-hexenyl ethylene diamine, N-heptenyl ethylene diamine, N-octenyl ethylene diamine, N-nonenyl ethylene diamine, N-decenyl ethylene diamine, N-undecenyl ethylene diamine, N-dodecenyl ethylene diamine, N-tridecenyl ethylene diamine, N-tetradecenyl ethylene diamine, N-pentadecenyl ethylene diamine, N-hexadecenyl ethylene diamine, N-heptadecenyl ethylene diamine, N-octadecenyl ethylene diamine, N-nonadecenyl ethylene diamine, N-icosenyl ethylene diamine, N-henicosenyl ethylene diamine, N-docosenyl ethylene diamine, and N-tricosenyl ethylene diamine; and N-alkyl or N-alkenylalkylenepolyamines such as N-alkyl diethylene triamine, N-alkenyl diethylene triamine, N-alkyl triethylene tetramine, N-alkenyl triethylene tetramine, N-alkyl tetraethylene pentamine, N-alkenyl tetraethylene pentamine, N-alkyl pentaethylene hexamine, N-alkenyl pentaethylene hexamine, N-alkyl propylene diamine, N-alkenyl propylene diamine, N-alkyl dipropylene triamine, N-alkenyl dipropylene triamine, N-alkyl tripropylene tetramine, N-alkenyl tripropylene tetramine, N-alkyl tetrapropylene pentamine, N-alkenyl tetrapropylene pentamine, N-alkyl pentapropylene hexamine, N-alkenyl pentapropylene hexamine, N-alkyl butylene diamine, N-alkenyl butylene diamine, N-alkyl dibutylene triamine, N-alkenyl dibutylene triamine, N-alkyl tributylene tetramine, N-alkenyl tributylene tetramine, N-alkyl tetrabutylene pentamine, N-alkenyl tetrabutylene pentamine, N-alkyl pentabutylene hexamine, and N-alkenyl pentabutylene hexamine, and also include all substituted isomers of these polyamines. Moreover, the polyamines described herein include polyamines (beef tallow polyamine and the like) which are derived from oils and fats.

Examples of the alkanolamines include monomethanolamine, dimethanolamine, trimethanolamine, monoethanolamine, diethanolamine, triethanolamine, mono(n-propanol)amine, di(n-propanol)amine, tri(n-propanol)amine, monoisopropanolamine, diisopropanolamine, triisopropanolamine, monobutanolamine, dibutanolamine, tributanolamine, monopentanolamine, dipentanolamine, tripentanolamine, monohexanolamine, dihexanolamine, monoheptanolamine, diheptanolamine, monooctanolamine, monononanolamine, monodecanolamine, monoundecanolamine, monododecanolamine, monotridecanolamine, monotetradecanolamine, monopentadecanolamine, monohexadecanolamine, diethyl monoethanol amine, diethyl monopropanol amine, diethyl monobutanol amine, diethyl monopentanol amine, dipropyl monoethanol amine, dipropyl monopropanol amine, dipropyl monobutanol amine, dipropyl monopentanol amine, dibutyl monoethanol amine, dibutyl monopropanol amine, dibutyl monobutanol amine, dibutyl monopentanol amine, monoethyl diethanol amine, monoethyl dipropanol amine, monoethyl dibutanol amine, monoethyl dipentanol amine, monopropyl diethanol amine, monopropyl dipropanol amine, monopropyl dibutanol amine, monopropyl dipentanol amine, monobutyl diethanol amine, monobutyl dipropanol amine, monobutyl dibutanol amine, monobutyl dipentanol amine, monocyclohexyl monoethanol amine, monocyclohexyl diethanol amine, monocyclohexyl monopropanol amine, and monocyclohexyl dipropanol amine, and also include all substituted isomers of these alkanolamines.

Among the above-described amines, monoamines are preferable from the viewpoint of rust preventive properties, and among monoamines, in particular, alkylamines, monoamines having an alkyl group and an alkenyl group, monoamines having an alkyl group and a cycloalkyl group, cycloalkylamines, and alkylcycloalkylamines are more preferable.

From the viewpoint of rust preventive properties, the total number of carbon atoms in a fatty acid amine molecule is preferably 12 or more, and from the viewpoint of prevention of stains, the total number of carbon atoms is preferably 24 or less.

The content of the fatty acid amine salt is not particularly limited, but is preferably 0.5 mass % or more, more preferably 1 mass % or more, and further preferably 2 mass % or more, and preferably 10 mass % or less, more preferably 8 mass % or less, and further preferably 6 mass % or less, based on the total amount of the rust preventive oil composition. When the content of the fatty acid amine salt is less than the above-described lower limit, a water removal property tends to decrease, and when it exceeds the above-described upper limit, a rust preventive property tends to decrease.

The rust preventive oil composition according to the present embodiment preferably further includes a sulfonic acid salt (D). Preferred examples of the sulfonic acid salt include sulfonic acid alkali metal salts, sulfonic acid alkali earth metal salts, and sulfonic acid amine salts. Every sulfonic acid salt has sufficiently-high safety for human bodies and ecosystems, and can be obtainable by reacting an alkali metal, an alkali earth metal, or an amine with sulfonic acid.

Examples of the alkali metal which constitutes the sulfonic acid salt include sodium and potassium. Moreover, examples of the alkali earth metal include magnesium, calcium, and barium. Among them, as the alkali metal and the alkali earth metal, sodium, potassium, calcium, and barium are preferable, and calcium is particularly preferable.

In the case where the sulfonic acid salt is amine salts, examples of the amines include monoamines, polyamines, and alkanolamines.

Examples of the monoamines, polyamines, and alkanolamines for use may include the same monoamines, polyamines, and alkanolamines as in the description of the fatty acid amine salt, respectively.

As the above-described sulfonic acid, those which are manufactured by a conventional method and well-known can be used. Specifically, general examples thereof include a petroleum sulfonic acids such as one obtainable by sulfonating an alkyl aromatic compound of lubricant oil distillate of a mineral oil; a so-called mahogany acid by-produced when manufacturing white oil; or synthetic sulfonic acids such as one obtainable by sulfonating an alkylbenzene having a straight-chain or branched-chain alkyl group, which is obtainable by alkylating benzene with a polyolefin by-produced from a manufacturing plant of an alkylbenzene which is to be a raw material for a detergent and the like, and one obtainable by sulfonating an alkylnaphthalene such as dinonylnaphthalene.

Examples of the sulfonic acid salts obtainable by using the above-described raw materials include the following: alkali metal bases such as alkali metal oxides or hydroxides; neutral (normal salt) sulfonates obtainable by reacting alkali earth metal bases such as alkali earth metal oxides or hydroxides, or amines such as ammonia, alkylamines, and alkanolamines with sulfonic acid; basic sulfonates obtainable by heating the above-described neutral (normal salt) sulfonates and excess alkali metal bases, alkali earth metal bases, or amines in the presence of water; carbonate overbasic (ultrabasic) sulfonates obtainable by reacting the above-described neutral (normal salt) sulfonates with alkali metal bases, alkali earth metal bases, or amines in the presence of carbon dioxide gas; borate overbasic (ultrabasic) sulfonates obtainable by reacting the above-described neutral (normal salt) sulfonates with alkali metal bases, alkali earth metal bases, or amines and boric acid compounds such as boric acid and anhydrous boric acid, or by reacting the above-described carbonate overbasic (ultrabasic) sulfonates with boric acid compounds such as boric acid and anhydrous boric acid, and mixtures thereof.

As the sulfonic acid salts, at least one selected from the group consisting of dialkylnaphthalene sulfonic acid salts in which the number of carbon atoms in total of two alkyl groups bonded to a naphthalene ring is 14 to 30; dialkylbenzene sulfonic acid salts in which each of two alkyl groups bonded to a benzene ring is a straight-chain alkyl group or a branched-chain alkyl group having one side-chain methyl group, and the number of carbon atoms in total of the two alkyl groups is 14 to 30; and monoalkylbenzene sulfonic acid salts in which the an alkyl group bonded to a benzene ring has the number of carbon atoms in alkyl group of 15 or more, is preferably used.

In the present embodiment, among the above, one or two or more selected from neutral, basic, and overbasic alkali metal sulfonates and alkali earth metal sulfonates are more preferably used; and neutral or nearly neutral alkali metal sulfonates or alkali earth metal sulfonates having a base value of 0 to 50 mgKOH/g, and preferably 10 to 30 mgKOH/g, and/or (over)basic alkali metal sulfonates or alkali earth metal sulfonates having a base value of 50 to 500 mgKOH/g, and preferably 200 to 400 mgKOH/g are particularly preferably used. Moreover, the mass ratio of the above-described alkali metal sulfonates or alkali earth metal sulfonates having a base value of 0 to 50 mgKOH/g to the alkali metal sulfonates or alkali earth metal sulfonates having a base value of 50 to 500 mgKOH/g (alkali metal sulfonates or alkali earth metal sulfonates having base value of 0 to 50 mgKOH/g/alkali metal sulfonates or alkali earth metal sulfonates having base value of 50 to 500 mgKOH/g) is preferably 0.1 to 30, more preferably 1 to 20, and particularly preferably 1.5 to 15, based on the total amount of the composition.

The base value herein means a base value measured by Hydrochloric acid method in conformity with JIS K 2501 “Petroleum products and lubricants-Determination of neutralization number”, Section 6, in the state where generally 30 to 70 mass % of a diluent such as a lubricant base oil is contained.

Among the above-described sulfonic acid salts, amine sulfonates, calcium sulfonate, and barium sulfonate are preferable, and alkylenediamine sulfonates and calcium sulfonate are particularly preferable.

The content of sulfonic acid salt is preferably 0.05 mass % or more, more preferably 0.1 mass % or more, furthermore preferably 0.5 mass % or more, and preferably 10 mass % or less, more preferably 8 mass % or less, furthermore preferably 6 mass % or less, based on the total amount of the rust preventive oil composition, though not particularly limited. With a content of sulfonic acid salt less than the lower limit, the rust preventive property tends to decrease, and with a content of sulfonic acid salt more than the upper limit, the water displacement property tends to decrease.

The rust preventive oil composition according to the present embodiment preferably farther includes one or more rust preventive agents selected from the group consisting of a sarcosine-type compound (E1), a nonionic surfactant (E2), a carboxylic acid (E3), a carboxylic acid salt (except for naphthenic acid) (E4), a paraffin wax (E5), an oxidized wax salt, and a boron compound.

The (E1) sarcosine-type compound has a structure represented by the following formula (1), (2), or (3):

R¹—CO—NR²—(CH₂)ₙ—COOX (3)

wherein, R¹ represents an alkyl group having 6 to 30 carbon atoms or an alkenyl group having the number of carbon atoms of 6 to 30, R² represents an alkyl group having the number of carbon atoms of 1 to 4, X represents a hydrogen atom, an alkyl group having the number of carbon atoms of 1 to 30, or an alkenyl group having the number of carbon atoms of 1 to 30, and n represents an integer of 1 to 4;

[R¹—CO—NR²—(CH₂)ₙ+COO]ₘY (4)

wherein, R¹ represents an alkyl group having the number of carbon atoms of 6 to 30 or an alkenyl group having the number of carbon atoms of 6 to 30, R² represents an alkyl group having the number of carbon atoms of 1 to 4, Y represents an alkali metal or an alkali earth metal, n represents an integer of 1 to 4, and m represents 1 when Y is an alkali metal, and represents 2 when Y is an alkali earth metal;

[R¹—CO—NR²—(CH₂)ₙ—COO]ₘ—Z—(OH)ₘ (5)
wherein, R¹ represents an alkyl group having the number of carbon atoms of 6 to 30 or an alkenyl group having the number of carbon atoms of 6 to 30, R² represents an alkyl group having the number of carbon atoms of 1 to 4, Z represents a residue other than hydroxyl groups of a dihydric or higher polyhydric alcohol, m represents an integer of 1 or more, m′ represents an integer of 0 or more, m+m′ represents a valence of Z, and n represents an integer of 1 to 4.

In the formulas (1) to (3), R¹ represents an alkyl group having the number of carbon atoms of 6 to 30 or an alkenyl group having the number of carbon atoms of 6 to 30. In terms of solubility in a base oil and the like, it is necessary that R³ be an alkyl group or an alkenyl group having the number of carbon atoms of 6 or more, and the number of carbon atoms is preferably 7 or more, and more preferably 8 or more. Moreover, in terms of storage stability and the like, it is necessary that R³ be an alkyl group or an alkenyl group having the number of carbon atoms of 30 or less, and the number of carbon atoms is preferably 24 or less, and more preferably 20 or less.

In the formulas (1) to (3), R² represents an alkyl group having the number of carbon atoms of 1 to 4. In terms of storage stability and the like, it is necessary that R⁴ be an alkyl group having the number of carbon atoms of 4 or less, and the number of carbon atoms is preferably 3 or less, and more preferably 2 or less.

In the formulas (1) to (3), n represents an integer of 1 to 4. In terms of storage stability and the like, it is necessary that n be an integer of 4 or less, n is preferably 3 or less, and n is more preferably 2 or less.

In the formula (1), X represents a hydrogen atom, an alkyl group having the number of carbon atoms of 1 to 30, or an alkenyl group having the number of carbon atoms of 1 to 30. In terms of storage stability and the like, it is necessary that an alkyl group or an alkenyl group represented by X have the number of carbon atoms of 30 or less, and the number of carbon atoms is preferably 20 or less, and more preferably 10 or less.

In the formula (2), Y represents an alkali metal or an alkali earth metal, and specifically, examples thereof include sodium, potassium, magnesium, calcium, and barium. Among them, in terms of a better rust preventive property, alkali earth metals are preferable. It is to be noted that, in the case of barium, safety for human bodies and ecosystems may become insufficient. In the formula (4), m represents 1 when Y is an alkali metal, and represents 2 when Y is an alkali earth metal.

In the formula (3), m represents an integer of 1 or more, m′ represents an integer of 0 or more, and m+m′ is the same as the valence of Z. That is, all of hydroxyl groups in a polyhydric alcohol of Z may be substituted or only a part thereof may be substituted.

Among the sarcosines represented by the above formulas (3) to (5), in terms of a better rust preventive property, at least one compound selected from the formulas (3) and (4) is preferable. Moreover, only one compound selected from the formulas (3) to (5) may be used alone, or a mixture of two or more compounds may be used.

The content of the sarcosines represented by the formulas (1) to (3) is not particularly limited, but is preferably 0.05 to 10 mass %, more preferably 0.1 to 7 mass %, and further preferably 0.3 to 5 mass %, based on the total amount of the composition. When the content of the sarcosines is less than the above-described lower limit, a rust preventive property and long-term sustainability thereof tend to become insufficient. Even when the content of the sarcosines exceeds the above-described upper limit, an improving effect of a rust preventive property and long-term sustainability thereof, which meets the content, does not tend to be obtained.

Specific examples of the nonionic surfactant (E2) include alkylene glycol, polyoxyalkylene glycol, polyoxyalkylene alkyl ether, polyoxyalkylene aryl ether, fatty acid ester of polyoxyalkylene adduct of polyalcohol, polyoxyalkylene fatty acid ester, polyoxyalkylene alkylamine, and alkyl alkanolamide. Among these, as nonionic surfactant for use in the present invention, alkylene glycol, polyoxyalkylene glycol, polyoxyalkylene alkyl ether, polyoxyalkylene aryl ether, and polyoxyalkylene alkylamine are preferred, and polyoxyalkylene glycol and polyoxyalkylene alkylamine are particularly preferred because they may impart a better rust preventive property to the rust preventive oil composition of the present invention.

The nonionic surfactant may be used alone, or two or more kinds of the nonionic surfactants may be used in combination. Although the rust preventive oil composition of the present invention may include no nonionic surfactant, in the case of containing a nonionic surfactant, the content is preferably 0.01 to 10 mass % based on the total amount of the rust preventive oil composition. From the viewpoint of rust preventive property, the upper limit of the content is preferably 10 mass % or less, more preferably 8 mass % or less, furthermore preferably 6 mass % or less, most preferably 5 mass % or less.

Any carboxylic acids can be used as the (E3) carboxylic acid, but preferable examples thereof include fatty acids, dicarboxylic acids, hydroxyfatty acids, naphthenic acids, resin acids, oxidized waxes, and lanolin fatty acid. The number of carbon atoms of the above-described fatty acids is not particularly limited, but is preferably 6 to 24, and more preferably 10 to 22. Moreover, the fatty acids may be saturated fatty acids or unsaturated fatty acids, and may be straight-chain fatty acids or branched-chain fatty acids.

Examples of these fatty acids include saturated fatty acids such as hexane acid, heptane acid, octane acid, nonane acid, decane acid, undecane acid, dodecane acid, tridecane acid, tetradecane acid, pentadecane acid, hexadecane acid, heptadecane acid, octadecane acid, nonadecane acid, icosane acid, henicosane acid, docosane acid, tricosane acid, and tetracosane acid; unsaturated fatty acids such as hexene acid, heptene acid, octene acid, nonene acid, decene acid, undecene acid, dodecene acid, tridecene acid, tetradecene acid, pentadecene acid, hexadecene acid, heptadecene acid, octadecene acid, nonadecene acid, icosene acid, henicosene acid, docosene acid, tricosene acid, and tetracosene acid; and mixtures thereof, and also include all substituted isomers of these fatty acids.

As the dicarboxylic acids, preferably, dicarboxylic acids having 2 to 40 carbon atoms, and more preferably, dicarboxylic acids having 5 to 36 carbon atoms are used. Among them, dimer acids obtainable by dimerizing unsaturated fatty acids having the number of carbon atoms of 6 to 18, and alkyl or alkenyl succinic acids are preferably used. Examples of the dimer acids include a dimer acid of oleic acid. Moreover, among the alkyl or alkenyl succinic acids, alkenyl succinic acids are preferable, and alkenyl succinic acids having an alkenyl group having the number of carbon atoms of 8 to 18 are more preferable.

As the hydroxyfatty acids, hydroxyfatty acids having the number of carbon atoms of 6 to 24 are preferably used. Although the number of hydroxy groups in the hydroxyfatty acids may be one or may be more than one, those having 1 to 3 hydroxy groups are preferably used. Examples of these hydroxyfatty acids include recinoleic acid.

The naphthenic acids indicate carboxylic acids in petroleum, which are compounds in which a —COOH group is bonded to a naphthene ring.

The resin acids indicate organic acids present in a free state or as esters in a natural resin.

The oxidized waxes are those obtainable by oxidizing waxes. Although the waxes used as a raw material are not particularly limited, specifically, examples thereof include paraffin waxes, microcrystalline waxes, and petrolatums obtainable when refining petroleum distillate, and polyolefin waxes obtainable by synthesis.

The lanolin fatty acid is a carboxylic acid obtained by refining, such as hydrolysis, of a waxy material that adheres to sheep wool.

Among these carboxylic acids, in terms of a rust preventive property, a degreasing property, and storage stability, naphthenic acids and dicarboxylic acids are preferable, naphthenic acids and dimer acids are more preferable, and naphthenic acids and a dimer acid of oleic acid are more preferable.

Examples of the (E5) carboxylic acid salt include alkali metal salts, alkali earth metal salts, and amine salts of the above-described carboxylic acids excluding naphthenic acids. Examples of the alkali metal which constitutes the carboxylic acid salt include sodium and potassium, and examples of the alkali earth metal include barium, calcium, and magnesium. Among them, a calcium salt is preferably used. Moreover, examples of the amine include the amines exemplified in the explanation of the amines. In the case of a barium salt, safety for human bodies and ecosystems may become insufficient.

Examples of the (E5) paraffin wax as a rust preventive component include paraffin waxes, microcrystalline waxes, and petrolatums obtainable when refining petroleum distillate, and polyolefin waxes obtainable by synthesis.

Although not particularly limited, examples of the oxidized wax used as a raw material for the (E6) oxidized wax salt include oxidized paraffin waxes produced by oxidizing waxes such as the above-described paraffin waxes.

When the oxidized wax salt is an alkali metal salt, examples of the alkali metal used as a raw material include sodium and potassium. When the oxidized wax salt is an alkali earth metal salt, examples of the alkali earth metal used as a raw material include magnesium, calcium, and barium. When the oxidized wax salt is a heavy metal salt, examples of the heavy metal used as a raw material include zinc and lead. Among them, a calcium salt is preferable. It is to be noted that, in terms of safety for human bodies and ecosystems, the oxidized wax salt is preferably not a barium salt and a heavy metal salt.

Examples of the (E7) boron compound include potassium borate and calcium borate.

In the present embodiment, one of the above-described rust preventive agents may be used alone, or a mixture of two or more of the same type of the rust preventive agents may be used, and furthermore, a mixture of two or more of the different types of the rust preventive agents may be used.

In terms of exhibiting a better rust preventive property, as the above-described rust preventive agents, a nonionic surfactant, a sarcosine acid, and a paraffin wax are preferable, and these three types are preferably used in combination.

In addition to the above-described rust preventive agents, alcohols typified by higher aliphatic alcohols; and phosphoric acid derivatives and phosphorous acid derivatives typified by amine salts of phosphoric acid monoesters, phosphoric acid diesters, phosphorous acid esters, phosphoric acid, and phosphorous acid can be contained as a rust preventive agent.

Although not particularly limited, in the case where the rust preventive agent other than the carboxylic acid of the above-described rust preventive agents is used, in terms of a rust preventive property, the content is preferably 0.1 mass % or more, more preferably 0.5 mass % or more, and further preferably 1.0 mass % or more, based on the total amount of the composition. Moreover, in terms of storage stability, the content of the rust preventive agent other than the carboxylic acid of the (D) component is preferably 20 mass % or less, more preferably 15 mass % or less, and further preferably 10 mass % or less, based on the total amount of the rust preventive oil composition.

Furthermore, although not particularly limited, in the case where the carboxylic acid of the above-described rust preventive agents is used as a rust preventive agent, in terms of a rust preventive property, the content is preferably 0.01 mass % or more, more preferably 0.03 mass % or more, and further preferably 0.05 mass % or more, based on the total amount of the composition. When the content of the carboxylic acid is less than the above-described lower limit, a rust preventive property improving effect by the addition may become insufficient. Moreover, the content of the carboxylic acid is preferably 2 mass % or less, more preferably 1.5 mass % or less, and further preferably 1 mass % or less, based on the total amount of the rust preventive oil composition. When the content of the carboxylic acid exceeds the above-described upper limit, solubility in a base oil becomes insufficient, and storage stability may decrease.

Although a chlorine bleaching agent is sometimes used for the purpose of decoloration when manufacturing the above-described rust preventive agent, it is preferable that, in the present embodiment, non-chlorine compounds such as hydrogen peroxide be used as a bleaching agent, or no decoloration treatment be carried out. Moreover, chlorine compounds such as hydrochloric acid are sometimes used in hydrolysis or the like of oils and fats, and in this case, it is preferable that non-chlorine acids or basic compounds be used. Furthermore, the compound to be obtainable is preferably subjected to sufficient washing treatment such as water washing.

The chlorine concentration of the above-described rust preventive agent is not particularly limited as long as properties of the rust preventive oil composition according to the present embodiment are not impaired, but it is preferably 200 mass ppm or less, more preferably 100 mass ppm or less, further preferably 50 mass ppm or less, and particularly preferably 25 mass ppm or less.

The kinematic viscosity at 40° C. of the rust preventive oil composition according to the present embodiment is preferably 0.1 mm²/s or more, more preferably 0.5 mm²/s or more, and further preferably 1.0 mm²/s or more, and preferably less than 20 mm²/s, more preferably 15 mm²/s or less, and further preferably 10 mm²/s or less, though not particularly limited. When the kinematic viscosity is less than 0.1 mm²/s, an oil film cannot be Maintained, and thus, problems with a rust preventive property may arise, and when it is 20 mm²/s or more, a rust generation factor removal property may decrease, which is not preferred.

The rust preventive oil composition of the present invention may further contain an ester base oil and an ester additive agent (collectively referred to as “ester”) in the range causing no problem in hydrolysis stability. Examples of the ester base oil include an ester of monohydric alcohol and monocarboxylic acid (referred to as monoester) and an ester of polyhydric alcohol and monocarboxylic acid and/or polycarboxylic acid (referred to as polyol ester); and examples of the ester additive agent include a partial ester of a polyhydric alcohol, an esterified oxidized wax, an esterified lanolin fatty acid, and an alkyl or alkenyl succinic acid ester. The content of ester is preferably 3 mass % or less, more preferably 1 mass % or less based on the total amount of the rust preventive oil composition, and no content of ester is particularly preferred.

The rust preventive oil composition according to the present embodiment may further contain other additive agents as necessary. Specifically, examples thereof include sulfurized oils and fats, sulfurized esters, long-chain alkylzinc dithiophosphates, phosphoric acid esters such as tricresyl phosphate, oils and fats such as lard, fatty acids, higher alcohols, calcium carbonate, and potassium borate which have significant press moldability improving effect and lubricating property improving effect; phenol-based or amine-based antioxidants for improving antioxidation performance; corrosion inhibitors for improving corrosion preventive performance, such as benzotriazole or a derivative thereof, thiadiazole, and benzothiazole; film-forming agents such as acrylic polymers and slack waxes; antifoaming agents such as methylsilicone, fluorosilicone, and polyacrylate, and mixtures thereof. It is to be noted that the content of the above-described other additive agents is arbitrary, but the total content of these additive agents is preferably 10 mass % or less based on the total amount of the rust preventive oil composition according to the present embodiment.

The rust preventive oil composition according to the present embodiment usually does not substantially contain water, is made not to contain water other than moisture that is naturally absorbed, and is used without being diluted with water intentionally. However, in the case of expecting the effect of finger print removal property, blending with 5 mass % or less of water is preferred, based on the total amount of the rust preventive oil composition.

In the rust preventive oil composition according to the present embodiment, the content of each of barium, chlorine, and lead is, in terms of element, preferably 1000 mass ppm or less, more preferably 500 mass ppm or less, further preferably 100 mass ppm or less, further more preferably 50 mass ppm or less, even more preferably 10 mass ppm or less, particularly preferably 5 mass ppm or less, and further preferably 1 mass ppm or less, based on the total amount of the composition. When either one of these elements has a content exceeding 1000 mass ppm, safety for environments such as human bodies and ecosystems may become insufficient.

It is to be noted that the content of the element in the present invention indicates a value measured by the following methods. That is, the content means a content (mass ppm) based on the total amount of the composition, measured in conformity with ASTM D 5185-95 in the case of barium, zinc, and lead, and IP “PROPOSED METHOD AK/81 Determination of chlorine Microcoulometry oxidative method” in the case of chlorine. The detection limit of each element in the above-described measuring methods is usually 1 mass ppm.

The rust preventive oil composition according to the present embodiment may achieve all of a rust preventive property, a rust generation factor removal property, a degreasing property, storage stability, and a washing property in a high level and a balanced manner, and may be suitably used as a rust preventive oil for various metal members. In particular, regarding a rust preventive property, time during which Grade A of rust generation (rust generation of 0%) is maintained in a salt water spray test specified by JIS K 2246 “Rust preventive oils” may be achieved 16 hours or more, and non-conventional excellent performance may be maintained.

The metal member that is a body to be treated is not particularly limited, and specifically, examples thereof include surface-treated steel sheets such as a cold-rolled steel sheet, a hot-rolled steel sheet, a high-tensile steel sheet, and a zinc-coated steel sheet, which are to be an automobile body or electrical product body, metal sheet materials such as a primitive sheet for tinning, an aluminum alloy sheet, and a magnesium alloy sheet, and furthermore, bearing parts such as a rolling bearing, a tapered rolling bearing, and a needle bearing, construction steel, and precision parts.

Conventional rust preventive oils for the foregoing metal members include intermediate rust preventive oils used during processes such as a working process of metal members, shipping rust preventive oils used to prevent rust during shipping, and washing rust preventive oils used during a washing process for removing foreign bodies before being subjected to press working or for removing foreign bodies before shipment in manufacturers of metal sheets, and the composition of the present invention can be used for all of these intended purposes.

The rust preventive oil composition according to the present embodiment has excellent water removal property and finger print removal property in addition to rust preventive property, so that excellent rust preventive effect may be exhibited even on a body to be treated having a surface to which water or stain such as a finger print is attached. Accordingly, the body to be treated to which the rust preventive oil composition according to the present embodiment is applied is not limited to a prewashed body to be treated, including a body to be treated not subjected to a washing treatment.

Namely, examples of the preferred aspect of a use of the composition according to the present embodiment include the following aspects (i) and (ii):

(i) A use of a composition as rust preventive oil composition,

the composition comprising a base oil comprising a mineral oil and a naphthenic acid salt, with the base oil content of 50 mass % or more based on the total amount of the composition,

the composition being applied to a washed body to be treated;

(ii) A use of a composition as rust preventive oil composition,

the composition comprising a base oil comprising a mineral oil and a naphthenic acid salt, with the base oil content of 50 mass % or more based on the total amount of the composition,

the composition being applied to an unwashed body to be treated.

Regarding to the components and the content of the composition, the body to be treated, and the like, the same as in the rust preventive oil composition according to the present embodiment is applied to the use describe above.

A method of applying the rust preventive oil composition according to the present embodiment to a body to be treated is not particularly limited, and for example, it may be applied to a metal member by spraying, dropping, transfer with a felt material or the like, electrostatic oiling and the like. Among these applying methods, the spraying method is preferable because an oil film thickness may be made uniform by application with fine mist. A coating applicator when using the spraying method is not particularly limited as long as the rust preventive oil composition according to the present embodiment may be atomized, and for example, any of an air spray type, an airless spray type, and a hot-melt type may be used. In the application process, after applying the excess washing and rust preventive oil composition, a step of draining using a centrifugal separator, or a step of draining by being left for long periods of time is preferably provided.

In the case where the rust preventive oil composition according to the present embodiment is used as a wash oil, a large excessive amount of the rust preventive oil composition according to the present embodiment is supplied to the surface of the metal member by spraying, showering, immersion application or the like so that good water removal and subsequent rust prevention may be carried out. Furthermore, by also carrying out surface cleaning using a roll brush or the like after the above-described metal working process as necessary, efficiency of removing foreign bodies may be increased.

When carrying out washing using the rust preventive oil composition according to the present embodiment, the amount of the oil attached to the surface of the metal member is preferably adjusted by also carrying out surface treatment of the metal member using a ringer roll or the like.

In every case of the above-described applying methods of the rust preventive oil composition according to the present embodiment, an excessive amount of the washing and rust preventive oil composition that has been applied to the metal member is preferably recovered, circulated, and reused. In addition, it is preferable that, when circulating the rust preventive oil composition according to the present embodiment, removal of foreign bodies mixed in a circulating system be also carried out. For example, the removal of foreign bodies may be carried out by providing a filter in a circulation pathway of the rust preventive oil composition according to the present embodiment, and preferably shortly before spraying the rust preventive oil composition according to the present embodiment toward the metal member. Moreover, by providing a magnet at the bottom of a tank that stores the rust preventive oil composition according to the present embodiment, foreign bodies such as abrasion powder may be absorbed by magnetic force to be removed.

Performance of the rust preventive oil composition reused in such a process may be decreased due to mixing of a preceding process oil or the like. Therefore, it is preferable that, when reusing the rust preventive oil composition according to the present embodiment, periodic measurement of the kinematic viscosity and the density of an oil to be used, a copper corrosion test, a rust preventive property test and the like be carried out to manage the properties, and oil change, drain disposal, tank cleaning, an oil purifying operation and the like be carried out as necessary.

Regarding a disposed oil solution, the oil solution is used directly, or with being diluted with a solvent or a low-viscosity base oil, in a line whose required performance for the washing and rust preventive oil composition is lower than a line used before disposal so that the total amount of the oil used may be decreased. When the rust preventive oil composition according to the present embodiment is stored in a tank, it is preferably supplied depending on the amount of the composition reduced in the tank. In this case, not always the same composition as the composition that is filled initially, but a composition in which an additive agent for eliciting performance to be enhanced is increased or the like may be supplied on a moment-to-moment basis. Alternatively, a composition whose viscosity is decreased by a method of reducing the content of a high-viscosity base oil or the like may be supplied to maintain washing capacity of the washing and rust preventive oil composition.

When the rust preventive oil composition according to the present embodiment is used in a washing process for removing foreign bodies before shipment in a manufacturer of metal sheets, metal sheets may be shipped by being wound in a coil immediately after the washing process or being stacked as sheet materials. This method has the advantage in that the amount of foreign bodies attached is small and washing may be easily and surely carried out even when carrying out the washing process with the washing rust preventive oil shortly before a press process in press working. It should be understood that rust preventive treatment may be carried out in two stages by providing a process of applying a rust preventive oil again after a washing process with a washing rust preventive oil at a steel sheet manufacturing place.

### EXAMPLES

Hereinafter, the present invention will be described in further detail with reference to examples and comparative examples, but the present invention is not limited to the following examples.

### Examples 1 to 56

### Comparative Examples 1 to 3

In Examples 1 to 56 and Comparative Examples 1 to 3, rust preventive oil compositions having compositions shown in Tables 1 to 8 were prepared, respectively, using components shown below.

(A) component
A1: a mineral oil having a kinematic viscosity at 40° C. of 0.7 mm²/s (aromatic component: 0.1 mass % or less)
A2: a mineral oil having a kinematic viscosity at 40° C. of 1.8 mm²/s (aromatic component: 0.1 mass % or less)
A3: a mineral oil having a kinematic viscosity at 40° C. of 2.3 mm²/s (aromatic component: 0.8 mass % or less)
A4: a mineral oil having a kinematic viscosity at 40° C. of 2.7 mm²/s (aromatic component: 9.8 mass % or less)
A5: a mineral oil having a kinematic viscosity at 40° C. of 6.5 mm²/s
A6: a mineral oil having a kinematic viscosity at 40° C. of 9.1 mm²/s
A7: a mineral oil having a kinematic viscosity at 40° C. of 64 mm²/s
A8: a mineral oil having a kinematic viscosity at 40° C. of 209 mm²/s
A9: a mineral oil having a kinematic viscosity at 40° C. of 260 mm²/s
A10: a mineral oil having a kinematic viscosity at 40° C. of 581 mm²/s
A11: a mineral oil having a kinematic viscosity at 40° C. of 667 mm²/s
A12: rapeseed oil (kinematic viscosity at 40° C.: 38 mm²/s)

### Component (B)

B1: zinc naphthenate
B2: calcium naphthenate
B3: copper naphthenate
B4: manganese naphthenate

### Component (C)

C1: hexylamine salt of hexanoic acid
C2: octylamine salt of octanoic acid
C3: octylamine salt of dodecanoic acid (lauric acid)
C4: dodecylamine salt of octanoic acid

### Component (D)

D1: ethylenediamine sulfonate
D2: calcium sulfonate (base value: 307 mg KOH/g)

### Component (E)

E1: oleoyl sarcosine (oleoyl(methyl)aminoacetic acid)
E2: copolymer of ethylene oxide and propylene oxide (molecular weight: 3400)
E3: naphthenic acid
E4: calcium oleate salt
E5: paraffin wax
E6: 2,6-di-tert-butyl-p-cresol (DBPC)
E7: benzo triazole (BTA)
E8: mixture of sorbitan monooleate and sorbitan dioleate

Next, for the respective rust preventive oil compositions of Examples 1 to 56 and Comparative Examples 1 to 3, the following evaluation tests were carried out.

<Rust Preventive Property Test 1>

The evaluation was carried out in conformity with a neutral salt water spray test of JIS K 2246 “Rust preventive oils”. Time (h) until rust was generated was measured and evaluated, and the evaluation was carried out each predetermined time (16, 24, 36, 48 hours). The sample oil was used within 24 hours after preparation. In the case that separation was observed due to poor stability of an oil solution, the sample was subjected to the test in a sufficiently stirred state.

<Rust Preventive Property Test 2>

The evaluation was carried out in conformity with a neutral salt water spray test of JIS K 2246 “Rust preventive oils” in the same way as in the rust preventive property test 1. In the present test, the sample oil was placed in a constant temperature and humidity bath at 50° C. and 95% RH immediately after preparation, left to stand for 30 days, and then used. In the case that separation, precipitation or the like was observed in the oil solution, the sample was subjected to the test in a sufficiently stirred state.

<Rust Preventive Property Test 3>

The evaluation was carried out in conformity with a neutral salt water spray test of JIS K 2246 “Rust preventive oils” in the same way as in the rust preventive property test 1. In the present test, the test piece was immersed in a sodium chloride aqueous solution with a concentration of 2 mass % for 10 seconds after polishing, and then oscillated for 1 minute, being kept in vertical position. The oscillation speed was set to 10 mm/s, and the sample piece reciprocated within a distance of 100 mm. The oil solution was then drained for 24 hours and evaluation was performed according to the testing method. By the testing method, the finger print removal property can be evaluated. In the case that water and sodium chloride contained therein are not completely removed, the rust occurs earlier in comparison with the rust preventive property test 1.

All of the rust preventive property tests 1, 2 and 3 using neutral salt water spray tests were performed 3 times for evaluation, considering the variation in data. The obtained results are shown in Tables 1 to 8. For example, “AAA” in the Tables means all the three evaluations were grade A.

TABLE 1

| | | Example 1 | Example 2 | Example 3 | Example 4 | Example 5 | Example 6 | Example 7 | Example 8 |
|---|---|---|---|---|---|---|---|---|---|
| Composition | A1 | 92 | | | | | | | |
| (mass %) | A2 | | 92 | | | | | | |
| | A3 | | | 92 | | | | | |
| | A4 | | | | 92 | | | | |
| | A5 | | | | | 92 | | | |
| | A6 | | | | | | 92 | | |
| | A7 | | | | | | | 92 | |
| | A8 | | | | | | | | 92 |
| | A9 | | | | | | | | |
| | A10 | | | | | | | | |
| | A11 | | | | | | | | |
| | B1 | 8 | 8 | 8 | 8 | 8 | 8 | 8 | 8 |
| | B2 | | | | | | | | |
| | B3 | | | | | | | | |
| | B4 | | | | | | | | |
| | C1 | | | | | | | | |
| | C2 | | | | | | | | |
| | C3 | | | | | | | | |
| | C4 | | | | | | | | |
| | D1 | | | | | | | | |
| | D2 | | | | | | | | |
| | E1 | | | | | | | | |
| | E2 | | | | | | | | |
| | E3 | | | | | | | | |
| | E4 | | | | | | | | |
| | E5 | | | | | | | | |
| | E6 | | | | | | | | |
| | E7 | | | | | | | | |
| | E8 | | | | | | | | |
| Kinematic | Base oil | 0.7 | 1.8 | 2.3 | 2.7 | 6.5 | 9.1 | 64 | 209 |
| viscosity at | Composition | 0.81 | 2.2 | 2.85 | 3.28 | 8.04 | 11.5 | 73.5 | 221 |
| 40° C. | | | | | | | | | |
| (mm²/s) | | | | | | | | | |
| Rust | 16 h | AAA | AAA | AAA | AAA | AAA | AAA | AAA | AAA |
| preventive | 24 h | AAB | AAB | AAB | ABB | AAB | AAB | ABB | AAB |
| property test 1 | 36 h | BCC | ABB | ABB | BBB | ABB | BBB | CCC | CCC |
| | 48 h | CDD | CCC | BCC | CDD | CCC | CCD | DDD | DDD |
| Rust | 16 h | AAA | AAA | AAA | AAA | AAA | AAA | AAA | AAA |
| preventive | 24 h | AAB | AAB | AAB | ABB | AAB | AAB | ABB | AAB |
| property test 2 | 36 h | BBC | BBB | ABB | ABB | ABB | BBB | BCC | CCC |
| | 48 h | CDD | CCC | BCC | CDD | CCC | CCD | DDD | DDE |
| Rust | 16 h | AAA | AAA | AAA | AAA | AAA | AAA | AAA | AAA |
| preventive | 24 h | BBB | BBB | BBB | BCC | BBB | BBB | BBB | BBB |
| property test 3 | 36 h | CCD | CCC | CCC | CCD | CCD | CCD | CDD | CDD |
| | 48 h | DEE | DDD | DDD | DEE | DDD | DDD | DEE | DEE |

TABLE 2

| | | | Example | Example | Example | Example | Example | Example | Example | Example |
|---|---|---|---|---|---|---|---|---|---|---|
| | | Example 9 | 10 | 11 | 12 | 12 | 13 | 14 | 15 | 16 |
| Composition | A1 | | | | | | | | | |
| (mass %) | A2 | | | | | 70 | 98 | 50 | 99 | 99.95 |
| | A3 | | | | | | | | | |
| | A4 | | | | | | | | | |
| | A5 | | | | | | | | | |
| | A6 | | | | | | | | | |
| | A7 | | | | | | | | | |
| | A8 | | | | 40 | | | | | |
| | A9 | 92 | | | | | | | | |
| | A10 | | 92 | | | | | | | |
| | A11 | | | 92 | | | | | | |
| | A12 | | | | 52 | | | | | |
| | B1 | 8 | 8 | 8 | 8 | 20 | 1 | 30 | 0.5 | 0.05 |
| | B2 | | | | | | | | | |
| | B3 | | | | | | | | | |
| | B4 | | | | | | | | | |
| | C1 | | | | | | | | | |
| | C2 | | | | | 10 | 1 | 20 | 0.5 | |
| | C3 | | | | | | | | | |
| | C4 | | | | | | | | | |
| | D1 | | | | | | | | | |
| | D2 | | | | | | | | | |
| | E1 | | | | | | | | | |
| | E2 | | | | | | | | | |
| | E3 | | | | | | | | | |
| | E4 | | | | | | | | | |
| | E5 | | | | | | | | | |
| | E6 | | | | | | | | | |
| | E7 | | | | | | | | | |
| Kinematic | Base oil | 260 | 581 | 667 | 74 | 1.8 | 1.8 | 1.8 | 1.8 | 1.8 |
| viscosity at | Composition | 280 | 584 | 668 | 85.6 | 4.12 | 1.92 | 8.54 | 1.88 | 1.75 |
| 40° C. | | | | | | | | | | |
| (mm²/s) | | | | | | | | | | |
| Rust | 16 h | AAA | AAA | AAA | AAA | AAA | AAA | AAA | AAA | AAA |
| preventive | 24 h | AAB | AAB | ABB | BBB | AAA | AAB | AAA | AAB | BCC |
| property test 1 | 36 h | CCC | BBC | BCC | CDD | ABB | AAB | BBC | BBB | CDD |
| | 48 h | DDD | CDD | DDD | EEE | BBC | CCC | CCC | CCC | EEE |
| Rust | 16 h | AAA | AAA | AAA | AAA | AAA | AAA | AAA | AAA | AAA |
| preventive | 24 h | AAB | AAB | ABB | BBB | AAA | AAB | AAA | AAB | CCC |
| property test 2 | 36 h | CCC | BBC | BCC | CDD | BBB | BBB | BCC | BBB | CDD |
| | 48 h | DDD | CDD | DDD | DEE | BCC | CCC | CCC | CCC | EEE |
| Rust | 16 h | AAA | AAA | AAA | AAA | AAA | AAA | AAA | AAA | AAA |
| preventive | 24 h | BBB | BBB | BBB | BCC | AAA | BBB | CCD | BBB | BCC |
| property test 3 | 36 h | DDD | CCD | CDD | DDD | ABB | CCB | DDE | CCB | DDD |
| | 48 h | DEE | DDE | DEE | EEE | BBB | CDD | EEE | CDD | EEE |

TABLE 3

| | | Example | Example | Example | Example | Example | Example | Example | Example |
|---|---|---|---|---|---|---|---|---|---|
| | | 17 | 18 | 19 | 20 | 21 | 22 | 23 | 24 |
| Composition | A1 | | | | | | | | |
| (mass %) | A2 | | | | | | 98 | 90 | 99.5 |
| | A3 | 55 | 46 | 51 | 52 | 41 | | | |
| | A4 | | | | | | | | |
| | A5 | | | | | | | | |
| | A6 | | | | | | | | |
| | A7 | | | | | | | | |
| | A8 | | | 41 | | 51 | | | |
| | A9 | | | | 40 | | | | |
| | A10 | 37 | 46 | | | | | | |
| | A11 | | | | | | | | |
| | B1 | 8 | 8 | 8 | 8 | 8 | 2 | 10 | 0.5 |
| | B2 | | | | | | | | |
| | B3 | | | | | | | | |
| | B4 | | | | | | | | |
| | C1 | | | | | | | | |
| | C2 | | | | | | | | |
| | C3 | | | | | | | | |
| | C4 | | | | | | | | |
| | D1 | | | | | | | | |
| | D2 | | | | | | | | |
| | E1 | | | | | | | | |
| | E2 | | | | | | | | |
| | E3 | | | | | | | | |
| | E4 | | | | | | | | |
| | E5 | | | | | | | | |
| | E6 | | | | | | | | |
| | E7 | | | | | | | | |
| | E8 | | | | | | | | |
| Kinematic | Base oil | 8.2 | 13 | 8.4 | 8.1 | 12.7 | 1.8 | 1.8 | 1.8 |
| viscosity at | Composition | 8.9 | 16.5 | 11.2 | 9.87 | 16.85 | 2.12 | 2.22 | 1.89 |
| 40° C. | | | | | | | | | |
| (mm²/s) | | | | | | | | | |
| Rust | 16 h | AAA | AAA | AAA | AAA | AAA | AAA | AAA | AAA |
| preventive | 24 h | AAA | AAA | AAA | AAA | AAA | AAA | AAB | AAB |
| property test 1 | 36 h | AAB | BCC | BBB | AAB | CCC | ABB | ABB | BBB |
| | 48 h | BCC | CDD | CCC | BCC | DDD | CCC | BBC | CDD |
| Rust | 16 h | AAA | AAA | AAA | AAA | AAA | AAA | AAA | AAA |
| preventive | 24 h | AAA | AAA | AAA | AAA | AAA | AAB | AAB | AAB |
| property test 2 | 36 h | AAB | BBC | BBC | AAB | BCC | BBB | BBB | BBB |
| | 48 h | BCC | CCD | CCC | BCC | CDD | CCC | BBC | CCD |
| Rust | 16 h | AAA | AAA | AAA | AAA | AAA | AAA | AAA | AAA |
| preventive | 24 h | BBB | BBB | BBB | BBB | BBB | BBB | BBB | BBB |
| property test 3 | 36 h | BBC | CDD | BCC | BCC | CDD | CCC | CCC | CCC |
| | 48 h | CDD | DDE | CDD | CDD | EEE | DDD | DDD | DDD |

TABLE 4

| | | Example | Example | Example | Example | Example | Example | Example | Example |
|---|---|---|---|---|---|---|---|---|---|
| | | 25 | 26 | 27 | 28 | 29 | 30 | 31 | 32 |
| Composition | A1 | | | | | | | | |
| (mass %) | A2 | 80 | 99.7 | 75 | | | | | |
| | A3 | | | | | | | | |
| | A4 | | | | | | | | |
| | A5 | | | | 92 | 92 | 92 | 92 | 92 |
| | A6 | | | | | | | | |
| | A7 | | | | | | | | |
| | A8 | | | | | | | | |
| | A9 | | | | | | | | |
| | A10 | | | | | | | | |
| | A11 | | | | | | | | |
| | B1 | 20 | 0.3 | 25 | | | | 5 | 5 |
| | B2 | | | | 8 | | | | |
| | B3 | | | | | 8 | | | |
| | B4 | | | | | | 8 | | |
| | C1 | | | | | | | 3 | |
| | C2 | | | | | | | | 3 |
| | C3 | | | | | | | | |
| | C4 | | | | | | | | |
| | D1 | | | | | | | | |
| | D2 | | | | | | | | |
| | E1 | | | | | | | | |
| | E2 | | | | | | | | |
| | E3 | | | | | | | | |
| | E4 | | | | | | | | |
| | E5 | | | | | | | | |
| | E6 | | | | | | | | |
| | E7 | | | | | | | | |
| | E8 | | | | | | | | |
| Kinematic | Base oil | 1.8 | 1.8 | 1.8 | 6.5 | 6.5 | 6.5 | 6.5 | 6.5 |
| viscosity at | Composition | 3.16 | 1.95 | 3.84 | 7.59 | 7.74 | 7.84 | 7.89 | 7.85 |
| 40° C. | | | | | | | | | |
| (mm²/s) | | | | | | | | | |
| Rust | 16 h | AAA | AAA | AAA | AAA | AAA | AAA | AAA | AAA |
| preventive | 24 h | AAB | BBB | AAB | AAB | AAB | ABB | AAA | AAA |
| property test 1 | 36 h | AAB | CCD | AAB | BBB | BBB | BBB | ABB | AAB |
| | 48 h | BBC | EEE | BBC | CCD | CCD | CCD | BCC | BBC |
| Rust | 16 h | AAA | AAA | AAA | AAA | AAA | AAA | AAA | AAA |
| preventive | 24 h | AAB | BBC | AAB | AAB | AAB | ABB | AAA | AAA |
| property test 2 | 36 h | BBB | CDD | BBB | BBB | BBC | BBC | ABC | AAB |
| | 48 h | BBC | EEE | BBB | CDD | CCD | CCD | BCC | BBC |
| Rust | 16 h | AAA | AAA | AAA | AAA | AAA | AAA | AAA | AAA |
| preventive | 24 h | BBC | BBB | CCC | ABB | BBB | BBC | AAA | AAA |
| property test 3 | 36 h | DDD | CDD | DDE | CCC | BCC | CCC | ABB | AAB |
| | 48 h | DDE | EEE | EEE | DEE | EEE | DDE | CCC | BBC |

TABLE 5

| | | Example | Example | Example | Example | Example | Example | Example | Example |
|---|---|---|---|---|---|---|---|---|---|
| | | 33 | 34 | 35 | 36 | 37 | 38 | 39 | 40 |
| Composition | A1 | | | | | | | | |
| (mass %) | A2 | | | 93 | 89 | 94.5 | 85 | 94.8 | 80 |
| | A3 | | | | | | | | |
| | A4 | | | | | | | | |
| | A5 | 92 | 92 | | | | | | |
| | A6 | | | | | | | | |
| | A7 | | | | | | | | |
| | A8 | | | | | | | | |
| | A9 | | | | | | | | |
| | A10 | | | | | | | | |
| | A11 | | | | | | | | |
| | B1 | 5 | 5 | 5 | 5 | 5 | 5 | 5 | 5 |
| | B2 | | | | | | | | |
| | B3 | | | | | | | | |
| | B4 | | | | | | | | |
| | C1 | | | | | | | | |
| | C2 | | | 2 | 6 | 0.5 | 10 | 0.2 | 15 |
| | C3 | 3 | | | | | | | |
| | C4 | | 3 | | | | | | |
| | D1 | | | | | | | | |
| | D2 | | | | | | | | |
| | E1 | | | | | | | | |
| | E2 | | | | | | | | |
| | E3 | | | | | | | | |
| | E4 | | | | | | | | |
| | E5 | | | | | | | | |
| | E6 | | | | | | | | |
| | E7 | | | | | | | | |
| | E8 | | | | | | | | |
| Kinematic | Base oil | 6.5 | 6.5 | 1.8 | 1.8 | 1.8 | 1.8 | 1.8 | 1.8 |
| viscosity at | Composition | 7.95 | 8.1 | 2.1 | 2.25 | 1.98 | 2.39 | 2.11 | 2.77 |
| 40° C. | | | | | | | | | |
| (mm²/s) | | | | | | | | | |
| Rust | 16 h | AAA | AAA | AAA | AAA | AAA | AAA | AAA | AAA |
| preventive | 24 h | AAA | AAA | AAA | AAA | AAA | AAA | AAA | ABB |
| property test 1 | 36 h | ABB | ABB | AAB | AAB | AAB | ABB | AAB | BBC |
| | 48 h | BCC | BCC | BBC | BBB | BCC | BBC | BCC | CCD |
| Rust | 16 h | AAA | AAA | AAA | AAA | AAA | AAA | AAA | AAA |
| preventive | 24 h | AAA | AAA | AAA | AAA | AAA | AAA | AAA | BBB |
| property test 2 | 36 h | AAB | ABB | AAB | AAB | AAB | BBB | AAB | BBC |
| | 48 h | BCC | BCC | BCC | BBC | BCC | BCC | BCC | CCD |
| Rust | 16 h | AAA | AAA | AAA | AAA | AAA | AAA | AAA | AAA |
| preventive | 24 h | AAA | AAA | AAA | AAA | AAA | AAA | BBC | AAB |
| property test 3 | 36 h | ABB | ABB | AAB | AAA | BBB | ABB | BCC | BBC |
| | 48 h | BCC | BCC | BBC | BBB | BCC | BBB | CCC | CCC |

TABLE 6

| | | Example | Example | Example | Example | Example | Example | Example | Example |
|---|---|---|---|---|---|---|---|---|---|
| | | 41 | 42 | 43 | 44 | 45 | 46 | 47 | 48 |
| Composition | A1 | | | | | | | | |
| (mass %) | A2 | | | | | | | | |
| | A3 | | | | | | | | |
| | A4 | | | | | | | | |
| | A5 | 92 | 92 | 92 | 91 | 91 | 91 | 91 | 91 |
| | A6 | | | | | | | | |
| | A7 | | | | | | | | |
| | A8 | | | | | | | | |
| | A9 | | | | | | | | |
| | A10 | | | | | | | | |
| | A11 | | | | | | | | |
| | B1 | 5 | 5 | 5 | 5 | 5 | 5 | 5 | 5 |
| | B2 | | | | | | | | |
| | B3 | | | | | | | | |
| | B4 | | | | | | | | |
| | C1 | | | 2 | 2 | 2 | 2 | 2 | 2 |
| | C2 | | | | | | | | |
| | C3 | | | | | | | | |
| | C4 | | | | | | | | |
| | D1 | 3 | | 1 | 1 | 1 | 1 | 1 | 1 |
| | D2 | | 3 | | | | | | |
| | E1 | | | | 1 | | | | |
| | E2 | | | | | 1 | | | |
| | E3 | | | | | | 1 | | |
| | E4 | | | | | | | 1 | |
| | E5 | | | | | | | | 1 |
| | E6 | | | | | | | | |
| | E7 | | | | | | | | |
| | E8 | | | | | | | | |
| Kinematic | Base oil | 6.5 | 6.5 | 6.5 | 6.5 | 6.5 | 6.5 | 6.5 | 6.5 |
| viscosity at | Composition | 7.85 | 7.99 | 7.68 | 8.17 | 8.3 | 7.86 | 7.88 | 7.59 |
| 40° C. | | | | | | | | | |
| (mm²/s) | | | | | | | | | |
| Rust | 16 h | AAA | AAA | AAA | AAA | AAA | AAA | AAA | AAA |
| preventive | 24 h | AAA | AAA | AAA | AAA | AAA | AAA | AAA | AAA |
| property test 1 | 36 h | AAA | AAA | AAA | AAA | AAA | AAA | AAA | AAA |
| | 48 h | BBC | BBC | BBB | ABB | BBB | ABB | ABB | AAA |
| Rust | 16 h | AAA | AAA | AAA | AAA | AAA | AAA | AAA | AAA |
| preventive | 24 h | AAA | AAA | AAA | AAA | AAA | AAA | AAA | AAA |
| property test 2 | 36 h | AAA | AAA | AAA | AAA | AAA | AAA | AAA | AAA |
| | 48 h | BCC | BBB | BBB | AAB | ABB | ABB | ABB | BCC |
| Rust | 16 h | AAA | AAA | AAA | AAA | AAA | AAA | AAA | AAA |
| preventive | 24 h | BBB | BBB | AAA | AAA | AAA | AAA | AAA | BBB |
| property test 3 | 36 h | BBC | BBC | AAB | AAB | AAA | ABB | ABB | BBC |
| | 48 h | BCC | BCC | BBC | BCC | BBB | BBB | BBB | BCC |

TABLE 7

| | | Example | Example | Example | Example | Example | Example | Example | Example |
|---|---|---|---|---|---|---|---|---|---|
| | | 49 | 50 | 51 | 52 | 53 | 54 | 55 | 56 |
| Composition | A1 | | | | | | | | |
| (mass %) | A2 | 92.5 | 87 | 92.95 | 83 | 92.99 | 78 | | |
| | A3 | | | | | | | 80 | |
| | A4 | | | | | | | | 80 |
| | A5 | | | | | | | | |
| | A6 | | | | | | | | |
| | A7 | | | | | | | | |
| | A8 | | | | | | | | |
| | A9 | | | | | | | | |
| | A10 | | | | | | | 9.49 | 9.49 |
| | A11 | | | | | | | | |
| | B1 | 5 | 5 | 5 | 5 | 5 | 5 | 4 | 4 |
| | B2 | | | | | | | | |
| | B3 | | | | | | | | |
| | B4 | | | | | | | | |
| | C1 | 2 | 2 | 2 | 2 | 2 | 2 | 2 | 2 |
| | C2 | | | | | | | | |
| | C3 | | | | | | | | |
| | C4 | | | | | | | | |
| | D1 | 0.5 | 6 | 0.05 | 10 | 0.01 | 15 | 1 | 1 |
| | D2 | | | | | | | | |
| | E1 | | | | | | | 1 | 1 |
| | E2 | | | | | | | 1 | 1 |
| | E3 | | | | | | | | |
| | E4 | | | | | | | | |
| | E5 | | | | | | | 1 | 1 |
| | E6 | | | | | | | 0.5 | 0.5 |
| | E7 | | | | | | | 0.01 | 0.01 |
| | E8 | | | | | | | | |
| Kinematic | Base oil | 1.8 | 1.8 | 1.8 | 1.8 | 1.8 | 1.8 | 3.07 | 3.6 |
| viscosity at | Composition | 2.14 | 2.39 | 2.22 | 2.54 | 2.21 | 2.79 | 3.88 | 3.85 |
| 40° C. | | | | | | | | | |
| (mm²/s) | | | | | | | | | |
| Rust | 16 h | AAA | AAA | AAA | AAA | AAA | AAA | AAA | AAA |
| preventive | 24 h | AAA | AAA | AAA | AAA | AAA | AAA | AAA | AAA |
| property test 1 | 36 h | AAA | AAA | AAA | AAA | AAB | AAA | AAA | AAB |
| | 48 h | BBB | ABB | BBC | AAB | BBC | AAB | AAA | ABB |
| Rust | 16 h | AAA | AAA | AAA | AAA | AAA | AAA | AAA | AAA |
| preventive | 24 h | AAA | AAA | AAA | AAA | AAA | AAA | AAA | AAA |
| property test 2 | 36 h | AAA | AAA | AAA | AAA | AAB | AAA | AAA | AAB |
| | 48 h | BBC | BBB | BCC | BBB | BCC | ABB | AAA | BBB |
| Rust | 16 h | AAA | AAA | AAA | AAA | AAA | AAA | AAA | AAA |
| preventive | 24 h | AAA | AAA | AAA | AAA | AAA | AAA | AAA | AAA |
| property test 3 | 36 h | AAB | AAB | AAA | BBB | AAB | BBC | AAA | AAB |
| | 48 h | BBB | BBB | BBC | BCC | BBC | CCC | AAA | ABB |

TABLE 8

| | | Comparative | Comparative |
|---|---|---|---|
| | | Example 1 | Example 2 |
| Composition | A1 | | |
| (mass %) | A2 | | |
| | A3 | | |
| | A4 | | |
| | A5 | 100 | 40 |
| | A6 | | |
| | A7 | | |
| | A8 | | |
| | A9 | | |
| | A10 | | |
| | A11 | | |
| | B1 | | 60 |
| | B2 | | |
| | B3 | | |
| | B4 | | |
| | C1 | | |
| | C2 | | |
| | C3 | | |
| | C4 | | |
| | D1 | | |
| | D2 | | |
| | E1 | | |
| | E2 | | |
| | E3 | | |
| | E4 | | |
| | E5 | | |
| | E6 | | |
| | E7 | | |
| | E8 | | |
| Kinematic | Base oil | 6.5 | 6.5 |
| viscosity at | Composition | 6.5 | 55.9 |
| 40° C. (mm²/s) | | | |
| Rust preventive | 16 h | EEE | AAA |
| property test 1 | 24 h | Discontinue | AAA |
| | 36 h | | AAA |
| | 48 h | | BCC |
| Rust preventive | 16 h | EEE | AAA |
| property test 2 | 24 h | Discontinue | AAA |
| | 36 h | | AAA |
| | 48 h | | CCC |
| Rust preventive | 16 h | EEE | CCD |
| property test 3 | 24 h | Discontinue | EEE |
| | 36 h | | Discontinue |
| | 48 h | | |

1. A rust preventive oil composition comprising:
a base oil comprising a mineral oil, and
a naphthenic acid salt;
the content of the base oil being 50 mass % or more based on a total amount of the rust preventive oil composition.

2. The rust preventive oil composition according to claim 1, wherein the mineral oil is a mixture of a mineral oil having a kinematic viscosity at 40° C. of 7 mm²/s or less and a mineral oil having a kinematic viscosity at 40° C. of 250 mm²/s or more.

3. The rust preventive oil composition according to claim 1, further comprising a fatty acid amine salt.

4. The rust preventive oil composition according to claim 1, further comprising a sulfonic acid salt.

5. The rust preventive oil composition according to claim 1, comprising no ester.

6. The rust preventive oil composition according to claim 1, wherein the kinematic viscosity at 40° C. of the rust preventive oil composition is 0.5 to 10 mm²/s.
